(19) United States
(12) Patent Application Publication
(10) Pub. No.: US 2007/0279567 A1
(43) Pub. Date: Dec. 6, 2007

(54) Liquid crystal device and electronic apparatus

(75) Inventor: Toshiharu Matsushima, Azumino-shi (JP)

Correspondence Address: OLIFF & BERRIDGE, PLC, P.O. BOX 19928, ALEXANDRIA, VA, 22320, US

(73) Assignee: EPSON IMAGING DEVICES CORPORATION, AZUMINO-SHI (JP)

(21) Appl. No.: 11/783,031

(22) Filed: Apr. 5, 2007

(30) Foreign Application Priority Data
Jun. 6, 2006 (JP) 2006-157010

(51) Int. Cl. G02F 1/1343

(52) U.S. Cl. 349/143

(57) ABSTRACT

A liquid crystal device includes a first substrate and a second substrate facing each other with a liquid crystal layer held therebetween; first electrodes and second electrodes provided on a surface of the first substrate, the surface facing toward the liquid crystal layer; data lines and scanning lines provided on the surface of the first substrate, the surface facing toward the liquid crystal layer, the data lines and the scanning lines intersecting one another; and switching elements connected to the corresponding data lines and the corresponding scanning lines. The alignment of liquid crystal molecules of the liquid crystal layer is controlled by an electric field induced between the first and second electrodes. The first electrodes are arranged in corresponding pixel regions enclosed by the data lines and the scanning lines. Each of the second electrodes has a plurality of branch electrodes extending in a direction intersecting a corresponding one of the data lines and a connecting portion electrically connecting the branch electrodes with one another such that at least one of first and second ends of the adjacent branch electrodes is open. The second electrodes are arranged such that each of the second electrodes partially overlaps a corresponding one of the first electrodes in a corresponding one of the pixel regions when viewed in plan.

### BACKGROUND

1. Technical Field

The present invention relates to liquid crystal devices and electronic apparatuses.

2. Related Art

In known liquid crystal devices using twisted nematic (TN) liquid crystal, the narrow viewing angle has been regarded as a problem. To solve this problem, liquid crystal devices in the fringe field switching (FFS) mode have been proposed. In such a liquid crystal device in the FFS mode, first electrodes and second electrodes are arranged on one of a pair of substrates sandwiching a liquid crystal layer, and the liquid crystal layer is driven by an electric field (horizontal electric field) induced between the first and second electrodes.

JP-A-2002-182230 discloses a liquid crystal device in the FFS mode in which color shift and disclination are prevented from occurring by forming rectangular apertures tilted at a predetermined angle in each of the second electrodes or pixel electrodes.

In the liquid crystal device described in JP-A-2002-182230, each of the pixel electrodes has an overall closed shape. In the liquid crystal device having such closed pixel electrodes, a horizontal electric field is induced mainly in a direction orthogonal to the long sides of each of the apertures. In contrast, at ends of each of the long sides of each aperture in a longitudinal direction, a horizontal electric field is generated mainly in a direction orthogonal to the short sides of each aperture. Accordingly, a reverse twist, which is a state where some of liquid crystal molecules are twisted in a reversed direction, is induced near the ends of each aperture where the horizontal electric fields are induced in the two directions. Transmitted light cannot be controlled strictly, and the brightness of a display region is reduced.

### SUMMARY

An advantage of some aspects of the invention is that it provides a liquid crystal device in the FFS mode, which is capable of performing a display operation with a higher brightness, and an electronic apparatus including the same.

A liquid crystal device according to an aspect of the invention includes a first substrate and a second substrate facing each other with a liquid crystal layer held therebetween; first electrodes and second electrodes provided on a surface of the first substrate, the surface facing toward the liquid crystal layer; data lines and scanning lines provided on the surface of the first substrate, the surface facing toward the liquid crystal layer, the data lines and the scanning lines intersecting one another; and switching elements connected to the corresponding data lines and the corresponding scanning lines. The alignment of liquid crystal molecules of the liquid crystal layer is controlled by an electric field induced between the first and second electrodes. The first electrodes are arranged in corresponding pixel regions enclosed by the data lines and the scanning lines. Each of the second electrodes has a plurality of branch electrodes extending in a direction intersecting a corresponding one of the data lines and a connecting portion electrically connecting the branch electrodes with one another such that at least one of first and second ends of the adjacent branch electrodes is open. The second electrodes are arranged such that each of the second electrodes partially overlaps a corresponding one of the first electrodes in a corresponding one of the pixel regions when viewed in plan.

In the liquid crystal device according to the aspect of the invention, at least one of first and second ends of the branch electrodes is open, which is an open end. A horizontal electric field mainly in a direction perpendicular to the direction in which the branch electrodes extend is induced between the open ends of the branch electrodes and the first electrode. This prevents a reverse twist from occurring near the open ends and increases the area in which the liquid crystal molecules are aligned satisfactorily, thereby improving the brightness. Since the direction in which the branch electrodes extend intersects the data lines with a lower potential difference relative to the second electrode (branch electrodes) than that of the scanning lines, an electric field induced between the signal lines including the scanning lines and the data lines and the branch electrodes is suppressed. Therefore, the liquid crystal can be reliably aligned by an electric field induced between the first and second electrodes.

Accordingly, a high-brightness, high-reliability liquid crystal device in the FFS mode can be provided.

It is preferable that the connecting portion be provided to connect to the first ends of the branch electrodes, and the second ends of the branch electrodes be open.

With the above structure, the brightness at one side of each of the pixel regions where the open ends of the branch electrodes are positioned can be intensively increased.

It is preferable that the connecting portion be provided such that the first and second ends of the adjacent branch electrodes are alternately open.

With the above structure, a high brightness area appears on both sides of each of the pixel regions, thereby equalizing the brightness in each of the pixel regions.

It is preferable that, when viewed in plan, a positional displacement between one of the first and second ends of each of the branch electrodes of each second electrode, the one end being open facing toward a corresponding one of the data lines, and one end of a corresponding one of the first electrodes adjacent to the corresponding one of the data lines be set to be less than or equal to 5 μm.

With the above structure, the occurrence of disclination at the boundary between the branch electrodes and the first electrode can be reduced, thereby improving the brightness in a display region.

It is preferable that an initial alignment direction of the liquid crystal molecules coincide with a direction of an electric field induced between the data lines and the first electrodes, and the initial alignment direction of the liquid crystal molecules intersects the direction in which the branch electrodes extend.

With the above structure, the direction of a leakage electric field induced between the data lines and the first electrodes coincides with the initial alignment direction of the liquid crystal. Thus, the leakage electric field does not disturb the initial alignment state of the liquid crystal near the data lines. Therefore, a normally black display operation can be performed without light-blocking films. Since the initial alignment direction of the liquid crystal intersects the direction in which the branch electrodes extend, the liquid crystal can be reliably rotated in the direction of a horizontal electric field induced between the branch electrodes and the first electrode, and a white display operation can be satisfactorily performed.

A liquid crystal device according to another aspect of the invention includes a first substrate and a second substrate facing each other with a liquid crystal layer held therebetween; first electrodes and second electrodes provided on a surface of the first substrate, the surface facing toward the liquid crystal layer; data lines and scanning lines provided on the surface of the first substrate, the surface facing toward the liquid crystal layer, the data lines and the scanning lines intersecting one another; and switching elements connected to the corresponding data lines and the corresponding scanning lines. The alignment of liquid crystal molecules of the liquid crystal layer is controlled by an electric field induced between the first and second electrodes. The first electrodes are arranged in corresponding pixel regions enclosed by the data lines and the scanning lines. The second electrodes are arranged such that at least part of each of the second electrodes overlaps a corresponding one of the first electrodes in a corresponding one of the pixel regions when viewed in plan. Each of the second electrodes has a plurality of branch electrodes formed by a plurality of slits crossing over at least one outer peripheral side of the second electrode adjacent to a corresponding one of the data lines and extending in a direction intersecting the corresponding one of the data lines, and at least one of two ends of each of the slits is open toward the outside of the second electrode.

In the liquid crystal device according to the aspect of the invention, at least one of first and second ends of the branch electrodes is open, defined by the slits, which is an open end. A horizontal electric field mainly in a direction perpendicular to the direction in which the branch electrodes extend is induced between the open ends of the branch electrodes and the first electrode. This prevents a reverse twist from occurring near the open ends and increases the area in which the liquid crystal molecules are aligned satisfactorily, thereby improving the brightness. Since the direction in which the branch electrodes extend intersects the data lines with a lower potential difference relative to the second electrode (branch electrodes) than that of the scanning lines, an electric field induced between the signal lines including the scanning lines and the data lines and the branch electrodes is suppressed. Therefore, the liquid crystal can be reliably aligned by an electric field induced between the first and second electrodes.

Accordingly, a high-brightness, high-reliability liquid crystal device in the FFS mode can be provided.

An electronic apparatus according to another aspect of the invention includes the above-described liquid crystal device.

The electronic apparatus according to the aspect of the invention has a bright, high-quality display section.

### BRIEF DESCRIPTION OF THE DRAWINGS

The invention will be described with reference to the accompanying drawings, wherein like numbers reference like elements.

FIG. 1 is a circuit diagram showing subpixel regions.

FIG. 2 is a plan view of the structure of one subpixel region.

FIG. 3 is a partial sectional view taken along the line III-III of FIG. 2;

FIG. 4 is a diagram showing an exemplary arrangement of optical axes in a liquid crystal device.

FIGS. 5A and 5B are diagrams showing the distribution of brightness depending on the shape of a pixel electrode.

FIG. 6 is a diagram showing the distribution of brightness in the case that an end of each of strip electrodes and an end of a common electrode do not coincide with each other.

FIG. 7 is a plan view of a modification of a first embodiment.

FIG. 8 is a plan view of a liquid crystal device according to a second embodiment.

FIG. 9 is a perspective view of an electronic apparatus according to an embodiment.

### DESCRIPTION OF EXEMPLARY EMBODIMENTS

### First Embodiment

A liquid crystal device according to a first embodiment of the invention will be described with reference to the drawings. The liquid crystal device according to the first embodiment is a liquid crystal device in the FFS mode. The FFS mode is one of horizontal electric field modes in which an image is displayed by applying an electric field (horizontal electric field) to liquid crystal in a direction of the surface of each substrate to control the alignment of the liquid crystal.

The liquid crystal device according to the first embodiment is a color liquid crystal device having color filters on the substrate. One pixel has three subpixels emitting red (R), green (G), and blue (B) light beams, respectively. A display region serving as the minimum unit constituting an image display region is referred to as a “subpixel region”, and a display region including a set of subpixels (R, G, and B) is referred to as a “pixel display region”.

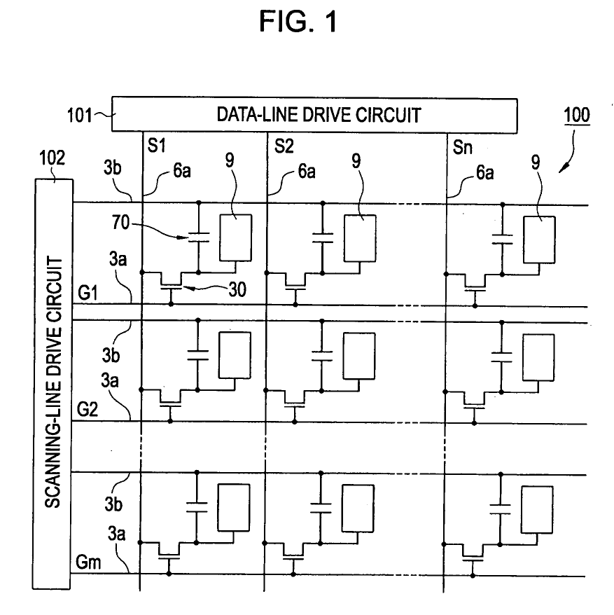

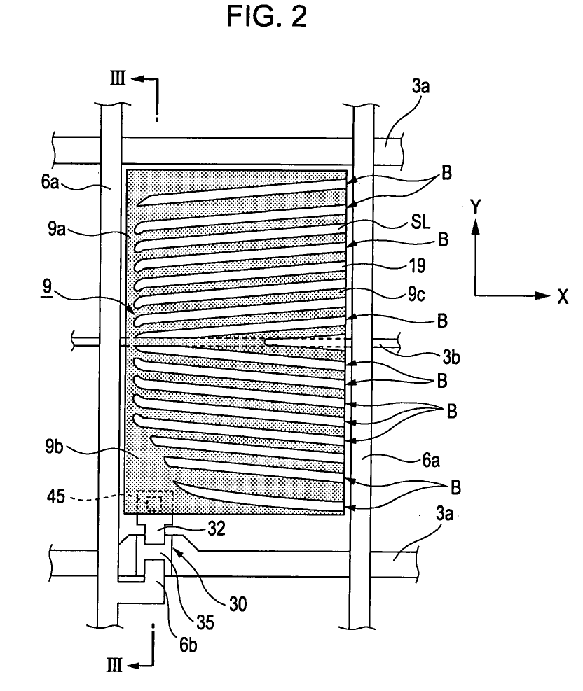

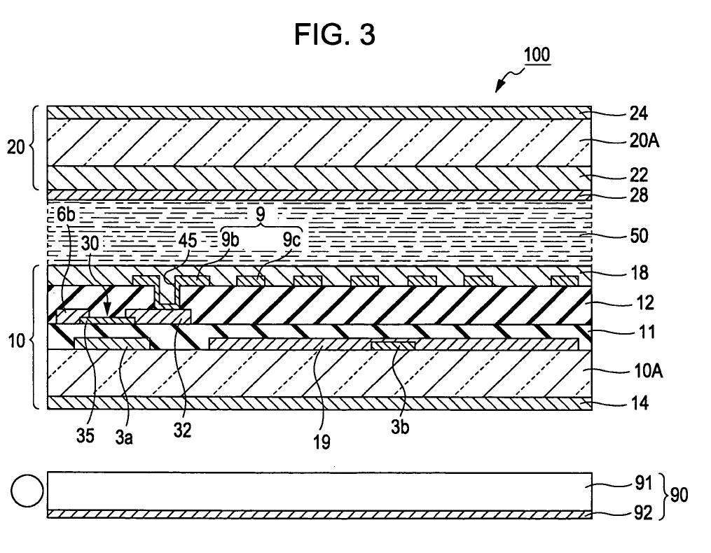

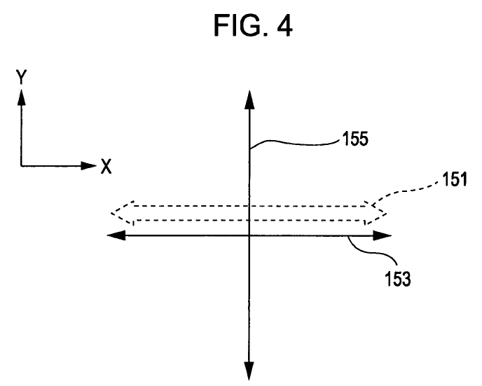

FIG. 1 is a circuit diagram showing a plurality of subpixel regions arranged in a matrix constituting the liquid crystal device according to the first embodiment. FIG. 2 is a plan view of the structure of any subpixel region of a liquid crystal device 100. FIG. 3 is a partial sectional view taken along the line III-III of FIG. 2. FIG. 4 is a diagram showing the arrangement of optical axes shown in FIG. 2.

In each of the drawings, each layer and component is shown at a different scale to improve viewability.

Referring to FIG. 1, each of the subpixel regions arranged in a matrix constituting an image display region of the liquid crystal device 100 includes a pixel electrode 9 and a thin-film transistor (TFT) 30 for switching on and off the pixel electrode 9. Data lines 6a extending from a data-line drive circuit 101 are electrically connected to the sources of the corresponding TFTs 30. The data-line drive circuit 101 supplies image signals S1, S2, . . . , and Sn to the corresponding pixels via the corresponding data lines 6a. The image signals S1 to Sn may be line-sequentially supplied in this order or may be supplied collectively to groups of adjacent data lines 6a.

Scanning lines 3a extending from a scanning-line drive circuit 102 are electrically connected to the gates of the corresponding TFTs 30. Scanning signals G1, G2, . . . , and Gm supplied as pulses with a predetermined timing from the scanning-line drive circuit 102 are line-sequentially applied in this order to the gates of the corresponding TFTs 30. The pixel electrodes 9 are electrically connected to the drains of the corresponding TFTS 30. The image signals S1, S2, . . . , and Sn supplied via the corresponding data lines 6a are written with a predetermined timing into the corresponding pixel electrodes 9 by turning on the TFTs 30 serving as switching elements for a certain period of time by inputting the scanning signals G1, G2, . . . , and Gm to the TFTs 30.

The image signals S1, S2, . . . , and Sn at predetermined levels written into the liquid crystal via the corresponding pixel electrodes 9 are maintained for a predetermined period of time between the pixel electrodes 9 and common electrodes 19 (see FIG. 2) facing the corresponding pixel electrodes 9. To prevent the maintained image signals from leaking, storage capacitors 70 are provided between the pixel electrodes 9 and the common electrodes 19. The storage capacitors 70 are connected to the drains of the corresponding TFTs 30 and to the corresponding common electrodes 19. The storage capacitors 70 are provided between common electrode lines 3b functioning also as capacitor lines.

Referring now to FIG. 2, the data lines 6a extending in the Y-axis direction shown in FIG. 2 and the scanning lines 3a extending in the X-axis direction shown in FIG. 2 intersect one another to form a matrix structure on a TFT array substrate 10. A region enclosed by the data lines 6a and the scanning lines 3a is a subpixel region constituting part of one pixel display region of the liquid crystal device 100. At the center of the subpixel region, the common electrode line 3b functioning also as a capacitor line extends parallel to the scanning lines 3a. The common electrode 19 is connected to the common electrode line 3b.

In each of the subpixel regions of the liquid crystal device 100, the pixel electrode 9 having a substantially forked shape (comb-like shape) when viewed in plan and the common electrode 19 connected to the common electrode line 3b are provided. The common electrode 19 is placed such that, when viewed in plan, the pixel electrode 9 and the common electrode 19 are substantially stacked on each other. Column-shaped spacers (not shown) for separating the TFT array substrate 10 from a counter substrate 20 at a predetermined distance are provided at the corners of the ends of each subpixel region (or between the subpixel regions).

A hatched region shown in FIG. 2 is the pixel electrode 9.

The pixel electrode 9 includes a plurality of strip electrodes 9c extending in the X-axis direction; a backbone portion 9a extending substantially in the Y-axis direction (direction in which the data lines 6a extend) and connecting to the strip electrodes 9c such that at least one of two ends of each of the strip electrodes 9c is open, thereby electrically connecting the left ends (on the −X side in FIG. 2) of the strip electrodes 9c with one another; and a contact portion 9b being provided on the −Y side of the backbone portion 9a and having a pixel contact hole 45. To simplify the description, the side at which each of the strip electrodes 9c is open is referred to as an open end B.

The pixel electrode 9 may include slits SL formed in, for example, a rectangular plate electrode. In this case, the pixel electrode 9 includes strip electrodes 9c defined by the slits SL crossing over one external peripheral side of the pixel electrode 9 adjacent to a corresponding one of the data lines 6a in the +X direction in FIG. 2 and extending in a direction intersecting the corresponding one of the data lines 6a. With this structure, the strip electrodes 9c are electrically connected to one another. Because of the slits SL, at least one of two ends of each of the adjacent strip electrodes 9c becomes the open end B.

In the first embodiment, the backbone portion 9a connecting the strip electrodes 9c with one another is positioned along one side of the subpixel region (in the −X direction shown in FIG. 2). The open ends B are formed only on the opposite side of the subpixel region (in the +X direction shown in FIG. 2).

One edge toward the open end B (in the +X direction shown in FIG. 2) of each of the strip electrodes 9c along a corresponding one of the data lines 6a and one edge of the common electrode 19 are substantially stacked on each other. The phrase “substantially stacked on each other” means that, when viewed in plan, the positional displacement between the edge of the common electrode 19 along the data line 6a and the edge of each strip electrode 9c along the data line 6a is set to be 5 μm or less. To achieve a higher brightness in the subpixel region, it is preferable to minimize this displacement by bringing the two edges together so that they coincide with each other, which will be described later.

The strip electrodes 9c constituting the pixel electrode 9 are symmetrical with respect to the common electrode line 3b. The shape of the pixel electrode 9 in the subpixel region divided by the common electrode line 3b into top and bottom portions will be described. In the top portion of the subpixel region, the strip electrodes 9c extend in a direction tilted by an angle of, for example, 5° to 20°, with respect to the X-axis.

In contrast, in the bottom portion of the subpixel region, the strip electrodes 9c extend in a direction tilted by an angle of, for example, −20° to −5°, with respect to the X-axis.

In the liquid crystal device 100 according to the first embodiment, each of the subpixel regions has two liquid crystal domains. This effectively prevents coloring of display viewed at different angles relative to the liquid crystal device 100.

The common electrode 19 is formed such that, when viewed in plan, the common electrode 19 and the pixel electrode 9 provided in each of the subpixel regions are stacked on each other. In the first embodiment, the common electrode 19 includes a conductive film made of a transparent conductive material, such as indium tin oxide (ITO) or the like.

Alternatively, the common electrode 19 may partially include, besides the transparent electrode made of the transparent conductive material as in the first embodiment, a reflective electrode made of, for example, a light-reflecting metal material. In this way, the invention is additionally applicable to a transflective liquid crystal device. In this case, the transparent electrode and the reflective electrode constitute a common electrode for inducing an electric field between the common electrode and the pixel electrode. At the same time, the reflective electrode additionally functions as a reflective layer of the subpixel region.

In each of the subpixel regions, the TFT 30 is provided near the intersection of the data line 6a and the scanning line 3a. The TFT 30 includes a semiconductor layer 35 that is made of amorphous silicon and is formed in part of a planar region corresponding to the scanning line 3a, and a source electrode 6b and a drain electrode 32 partially overlapping the semiconductor layer 35 when viewed in plan. A portion of the scanning line 3a lying below the semiconductor layer 35 when viewed in plan functions as a gate electrode of the TFT 30.

The source electrode 6b of the TFT 30 has substantially an L shape in plan view and extends from the data line 6a to the semiconductor layer 35. The drain electrode 32 is positioned such that the drain electrode 32 and the contact portion 9b of the pixel electrode 9 are stacked on each another when viewed in plan. The drain electrode 32 and the pixel electrode 9 are electrically connected to each other via the pixel contact hole 45. The pixel electrode 9 is stacked on the common electrode 19 with an insulating film therebetween, which will be described later. With this structure, a storage capacitor (not shown) is formed at a position at which the pixel electrode 9 and the common electrode 19 are stacked on each other when viewed in plan.

With reference to the sectional structure shown in FIG. 3, the liquid crystal device 100 includes the TFT array substrate 10, the counter substrate 20, the pixel electrode 9, and the common electrode 19. The TFT array substrate 10 and the counter substrate 20 face each other with a liquid crystal layer 50 therebetween. The liquid crystal layer 50 includes liquid crystal molecules having positive dielectric anisotropy. The pixel electrode 9 and the common electrode 19 are arranged on a surface of the TFT array substrate 10, the surface facing toward the liquid crystal layer 50. A backlight 90 is arranged on an outer surface of the TFT array substrate 10 (opposite to the liquid crystal layer 50).

A basic portion of the TFT array substrate 10 is a substrate main portion 10A made of glass, quartz, plastic, or the like. The scanning line 3a, the common electrode line 3b, and the common electrode 19 connected to the common electrode line 3b are formed on an inner surface of the substrate main portion 10A (the inner surface facing toward the liquid crystal layer 50). A gate insulating film 11 is formed so as to cover the scanning line 3a, the common electrode line 3b, and the common electrode 19.

The semiconductor layer 35 made of amorphous silicon is formed on the gate insulating film 11. The source electrode 6b and the drain electrode 32 are formed such that the source electrode 6b and the drain electrode 32 partially overlap and cover the semiconductor layer 35. The semiconductor layer 35 is positioned facing toward the scanning line 3a via the gate insulating film 11. In this region where the semiconductor layer 35 faces toward the scanning line 3a, the scanning line 3a constitutes the gate electrode of the TFT 30.

In the subpixel region shown in FIG. 2 of the liquid crystal device 100 according to the first embodiment, a planar region where the common electrode 19 is formed serves as a pixel display region that displays an image by modulating light that is emitted from the backlight 90 and passes through the liquid crystal layer 50.

An interlayer insulating film 12 made of silicon oxide or the like is formed covering the TFT 30. The pixel electrode 9 made of the transparent conductive material such as ITO or the like is formed on the interlayer insulating film 12.

An alignment film 18 made of polyimide, silicon oxide, or the like is formed covering the pixel electrode 9 and the interlayer insulating film 12.

The pixel contact hole 45 penetrates through the interlayer insulating film 12 and reaches the drain electrode 32. Part of the contact portion 9b of the pixel electrode 9 is formed in the pixel contact hole 45, thereby electrically connecting the pixel electrode 9 to the TFT 30.

In contrast, the counter substrate 20 includes a transparent substrate main portion 20A made of glass, quartz, plastic, or the like. A color filter 22 is provided on an inner surface of the substrate main portion 20A (the inner surface facing toward the liquid crystal layer 50). An alignment film 28 made of polyimide or the like is laminated on the color filter 22. It is preferable that an additional planarizing film made of a transparent resin material or the like be laminated on the color filter 22. In this way, the surface of the counter substrate 20 can be planarized, thereby obtaining a uniform thickness of the liquid crystal layer 50. This prevents contrast reduction due to differences in drive voltage in the subpixel region.

A polarizing plate 14 is disposed on an outer surface of the substrate main portion 10A, and a polarizing plate 24 is disposed on an outer surface of the substrate main portion 20A. One or multiple retardation plates (optical compensating plates) can be provided between the polarizing plate 14 and the substrate main portion 10A and between the polarizing plate 24 and the substrate main portion 20A.

Referring now to FIG. 4, an exemplary arrangement of optical axes in the liquid crystal device 100 according to the first embodiment will be described.

A transmission axis 153 of the polarizing plate 14 on the TFT array substrate 10 is arranged to be perpendicular to a transmission axis 155 of the polarizing plate 24 on the counter substrate 20.

The alignment films 18 and 28 are rubbed in the same direction when viewed in plan. This direction is a rubbing direction 151 (initial alignment direction of the liquid crystal) shown in FIG. 4. The rubbing direction 151 is parallel to the transmission axis 153 of the polarizing plate 14, which corresponds to the X-axis direction.

In the first embodiment, the rubbing direction 151 corresponds to the X-axis direction shown in FIG. 2 (orthogonal to the data lines 6a), that is, the direction of an electric field induced between the data lines 6a and the common electrodes 19. As has been described above, the strip electrodes 9c extend in a direction tilted by an angle of about 5° to 20° with respect to the. X-axis direction shown in FIG. 2. Therefore, the rubbing direction 151 intersects the direction in which the strip electrodes 9c extend.

Even with application of a horizontal electric field in a direction orthogonal to the initially aligned liquid crystal molecules, the liquid crystal molecules cannot be rotated.

With the structure of the first embodiment, the main direction (perpendicular to the direction in which the strip electrodes 9c extend) of a horizontal electric field (electric field) formed between the pixel electrode 9 and the common electrode 19 is not perpendicular to the rubbing direction 151 (the initial alignment direction of the liquid crystal molecules) of the alignment films 18 and 28. Therefore, the liquid crystal molecules can be rotated in the direction of the horizontal electric field.

With this structure, a leakage electric field induced between the data lines 6a and the common electrodes 19 corresponds to the rubbing direction 151. Thus, the initially aligned liquid crystal molecules near the data lines 6a are not affected by the leakage electric field, and the initial alignment state of the liquid crystal is not disturbed. In the liquid crystal device 100 according to the first embodiment, light-blocking films for preventing light leakage near the data lines 6a become unnecessary, and a normally black display operation can be satisfactorily performed. In case that the liquid crystal molecules are aligned in the rubbing direction 151 due to the leakage electric field during the operation of the liquid crystal device 100, black is simply displayed in a normally black display operation, and there will be no serious influence on the contrast. Since the rubbing direction 151 intersects the direction in which the strip electrodes 9c extend, the liquid crystal can be reliably aligned by an electric field induced between the strip electrodes 9c and the common electrode 19.

Next, the operation of the liquid crystal device 100 will be described. With application of a non-selection voltage, the liquid crystal molecules constituting the liquid crystal layer 50 are aligned horizontally relative to the substrates in the rubbing direction 151. With application of a selection voltage between the pixel electrode 9 and the common electrode 19, a horizontal electric field is induced in a direction perpendicular to the direction in which the strip electrodes 9c and 109c extend (Y-axis direction), and the liquid crystal molecules are realigned along the direction of the horizontal electric field. In the first embodiment, as has been described above, the rubbing direction 151 of the alignment films 18 and 28 is set to intersect the direction of the horizontal electric field at angles other than right angles. Thus, all the liquid crystal molecules can be rotated in the direction of the horizontal electric field. The liquid crystal device 100 achieves contrast in a display operation using birefringence based on differences in the alignment state of the liquid crystal molecules.

In the liquid crystal device 100 in the FFS mode according to the first embodiment, the liquid crystal is aligned by a horizontal electric field induced at the boundary between the pixel electrode 9 and the common electrode 19. Therefore, the main direction of the horizontal electric field changes depending on the shape of the pixel electrode 9, thereby changing the alignment state of the liquid crystal.

A comparison is made between the case of a pixel electrode having a closed shape without an open end and the case of a pixel electrode having an open end, as in the liquid crystal device according to the first embodiment. The distribution of brightness (luminance) in a subpixel region depending on the shape of the pixel electrode will be described.

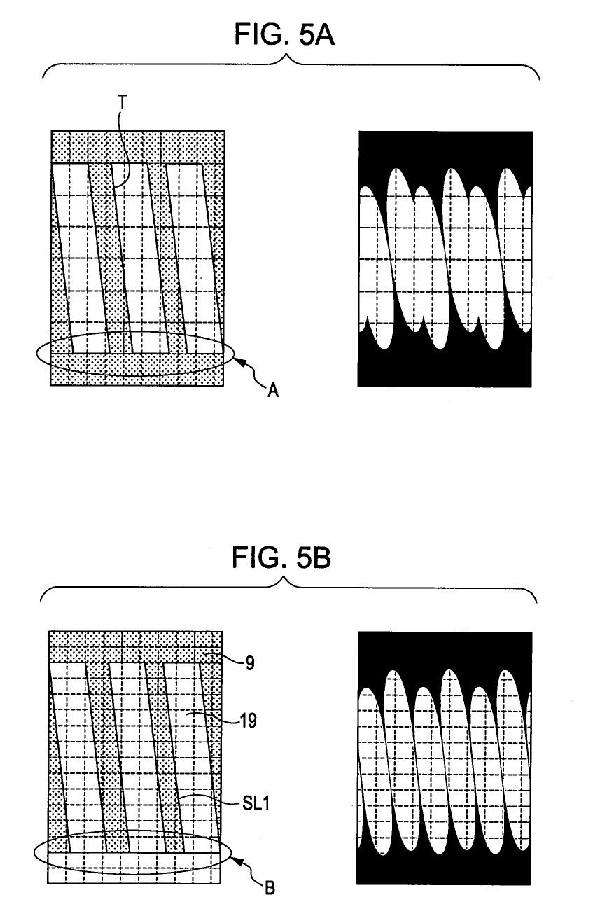

The left-hand side of FIG. 5A shows an overall closed pixel electrode (hatched portion shown in FIG. 5A) having apertures T. A common electrode is placed facing the pixel electrode in the thickness direction. The right-hand side of FIG. 5A shows the contrast (black and white) resulting from an electric field induced between the pixel electrode and the common electrode.

The left-hand side of FIG. 5B shows a pixel electrode (hatched portion shown in FIG. 5B) having slits S1 and an open end B. As in FIG. 5A, a common electrode is placed facing the pixel electrode.

Generally in the FFS mode, a portion near the boundary between the pixel electrode and the common electrode in which a horizontal electric field is induced becomes bright, and the electrodes and the central portions of the apertures T in which no horizontal electric field is induced become dark. Accordingly, the pixel electrode shaped as shown in the left-hand side of FIG. 5A is estimated to have such a brightness distribution that bright portions are distributed along the shape of each aperture T.

However since two horizontal electric fields, one with a main direction perpendicular to the long sides of each of the apertures T and the other with a main direction perpendicular to the short sides of each of the apertures T, are induced in portion A shown in FIG. 5A, the direction in which the liquid crystal molecules are twisted is changed step by step. This induces a reverse twist, which is a state where the liquid crystal molecules are twisted in a reversed direction.

Due to the reverse twist, transmitted light cannot be controlled strictly, and the brightness of the subpixel region is reduced. In addition, disclination occurs in portion A shown in FIG. 5A, resulting in a reduction of brightness, as shown in FIG. 5A.

In contrast, the pixel electrode shown in FIG. 5B has an open end (portion B shown in FIG. 5B) defined by the slits S1 formed so as to cross over the outer peripheral side of the pixel electrode. That is, the pixel electrode shown in FIG. 5B has a structure similar to that of the pixel electrode 9 of the liquid crystal device 100 according to the first embodiment.

Since there is no pixel electrode 9 in the open end B, a horizontal electric field is induced only in a direction perpendicular to the direction in which the slits S1 extend, and the liquid crystal molecules are not twisted in a reversed direction due to multiple electric fields. As a result, no reverse twist occurs. With the pixel electrode having such an open end, the area in which the liquid crystal molecules are aligned or twisted in a desired direction is increased. As shown in FIG. 5B, the open end portion (region B shown in FIG. 5B) becomes brighter, and the brightness of the subpixel region is improved.

Referring to FIG. 5B, the open end B of the pixel electrode 9 and one end of the common electrode 19 are substantially stacked on each other when viewed in plan, thereby avoiding disclination in the open end portion B.

With the pixel electrode 9 having the open end B, as shown in the right-hand side of FIG. 5B, a bright portion near the open end B becomes larger than that in the case of the pixel electrode having no open end (see FIG. 5A), thereby improving the brightness of a display region.

It is preferable that, as has been described above, the end of the pixel electrode 9 (toward the open end B) coincide with the end of the common electrode 19. However, the actual design may have to tolerate some displacement between the pixel electrode 9 and the common electrode 19.

Preferably, the tolerance value is such that the positional displacement between the open end B of each strip electrode 9c and the end of the common electrode 19 when viewed in plan is less than or equal to 5 μm.

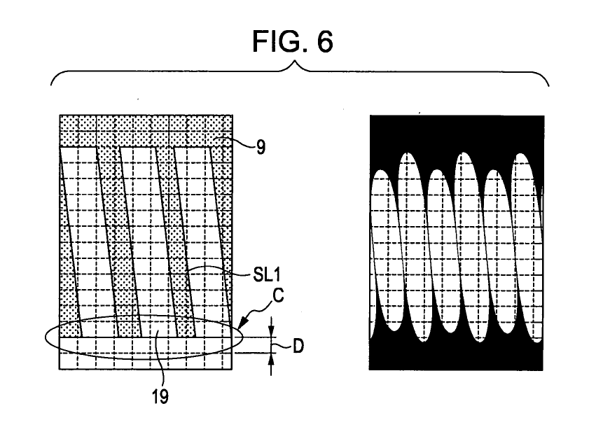

The right-hand side of FIG. 6 shows the contrast in the subpixel region in the case that the common electrode 19 protrudes externally from the pixel electrode 9 (strip electrodes 9c) shown in FIG. 5B by 5 μm. In other words, the positional displacement D between the pixel electrode 9 and the common electrode 19 is 5 μm (see the left-hand side of FIG. 6).

In the case of such a displacement between the pixel electrode 9 and the common electrode 19, disclination occurs at the end of the pixel electrode 9 (portion C shown in FIG. 6), and part of the bright region near the open end is retracted or reduced. In comparison with the case shown in FIG. 5B, the brightness of the subpixel region is somewhat reduced. However, even with such a displacement of about ±5 μm, sufficiently high brightness can be achieved, compared with the case that there is no open end, as shown in FIG. 5A.

As has been described above, since the liquid crystal device 100 according to the first embodiment has a structure with the open ends B in which at least one of two ends of each of the strip electrodes 9c constituting each pixel electrode 9 is open, an electric field is induced in one direction between the open-end portions of the strip electrodes 9c and the common electrode 19. This prevents a reverse twist from occurring near the open ends B. As a result, the area in which the liquid crystal molecules are aligned satisfactorily is increased, and the brightness of each subpixel region is improved.

In the liquid crystal device 100 according to the first embodiment, as shown in FIG. 2, the strip electrodes 9c extend toward a corresponding one of the data lines 6a. As shown in the equivalent circuit shown in FIG. 1, the image signals S1 to Sn are supplied via the corresponding data lines 6a to the pixel electrodes 9 using the TFTs 30 as switching elements. The potential difference between the data lines 6a and the corresponding pixel electrodes 9 is less than the potential difference between the scanning lines 3a and the corresponding pixel electrodes 9.

In the liquid crystal device 100 according to the first embodiment, the strip electrodes 9c extend in a direction intersecting a corresponding one of the data lines 6a with a lower potential difference. Therefore, an electric field induced between the strip electrodes 9c and the data line 6a is suppressed. By suppressing an electric field formed between the signal lines (scanning lines 3a and data lines 6a) and the strip electrodes 9c in this manner, the liquid crystal can be reliably aligned by a horizontal electric field induced between the pixel electrode 9 and the common electrode 19. Therefore, the liquid crystal device 100 according to the first embodiment has higher brightness and reliability.

The positional displacement between the end of each of the strip electrodes 9c facing a corresponding one of the data lines 6a and the end of the common electrode 19 is less than or equal to 5 μm when viewed in plan. Thus, as has been described with reference to FIG. 6, disclination at the boundary between the open end B of the pixel electrode 9 and the common electrode 19 is reduced, resulting in improvement of the brightness in the subpixel region.

In the first embodiment, for convenience, the initial alignment direction of the liquid crystal molecules of the liquid crystal layer 50 near the alignment films 18 and 28 is regarded as the rubbing direction. However, the alignment films 18 and 28 are not limited to those in which the direction in which the liquid crystal molecules are initially aligned is defined by a rubbing treatment. Alternatively, alignment films in which the initial alignment direction of the liquid crystal molecules is defined by, for example, photo-alignment or oblique evaporation may be used.

### Modification

A modification of the first embodiment of the invention will be described with reference to the drawing.

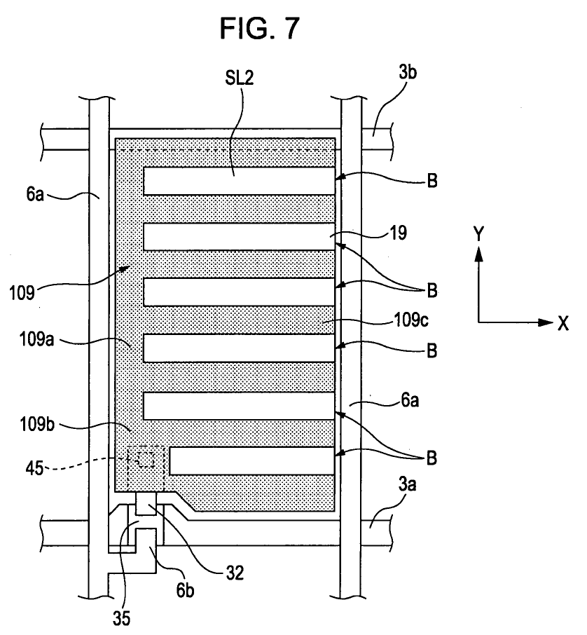

In a liquid crystal device according to the modification, as shown in FIG. 7, strip electrodes 109c constituting a pixel electrode 109 extend parallel to the X-axis direction. The pixel electrode 109 has a substantially comb-like shape. In the modification, the common electrode line 3b is formed near the scanning line 3a, and the common electrode 19 is connected to the common-electrode line 3b.

In the modification, as has been described above, the direction in which the strip electrodes 109c extend is the X-axis direction shown in FIG. 7. When the X-axis direction is the horizontal direction, the rubbing direction is set to be within a range of about ±3° to ±15°. However, the rubbing direction is not limited to this range. Any rubbing direction can be set as long as the rubbing direction intersects the direction of a horizontal electric field induced between the strip electrodes 109c and the common electrode 19 at angles other than right angles.

The pixel electrode 109 with such a shape can be easily formed to have open ends B by providing slits S2 in the pixel electrode 109 such that, for example, part of the outer periphery of a plate electrode (serving as the pixel electrode 109) of substantially the same size as that of the common electrode 19 is open. Alternatively, multiple strip electrodes 109c are prepared, and first ends of the strip electrodes 109c are connected to one another by a backbone portion 109a, thereby forming the pixel electrode 109 with the open ends B.

Even in the case of the pixel electrode 109 with such a shape, the pixel electrode 109 has the open ends B, as in the liquid crystal device according to the first embodiment described above. Therefore, a display operation with a high brightness can be performed. The shape of the pixel electrode 109 or the number of strip electrodes 109c is not limited to that shown in FIG. 7, and various modifications can be made.

### Second Embodiment

A second embodiment of the invention will be described with reference to the drawing.

A liquid crystal device according to the second embodiment differs from those described in the first embodiment and the modification in that a backbone portion 209a that connects multiple strip electrodes 209c with one another covers two ends of the adjacent strip electrodes 209c. The components of the liquid crystal device according to the second embodiment, that is, the liquid crystal layer 50, the TFT array substrate 10, the counter substrate 20, the polarizing plates 14 and 24, and the like, are the same as those of the first embodiment. In the following description, descriptions of portions common to the first embodiment and the modification are omitted.

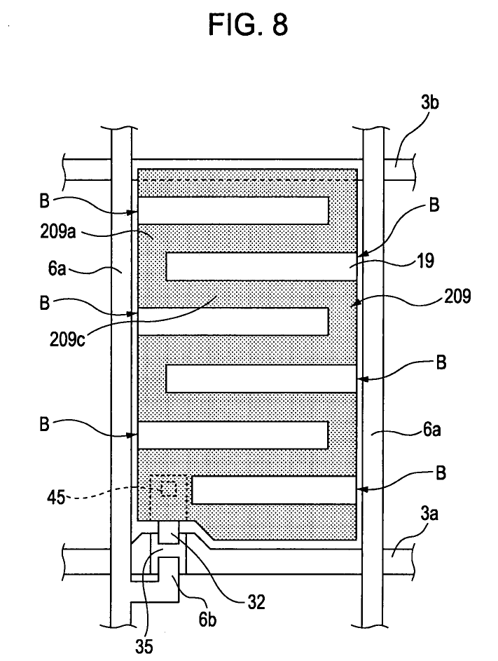

FIG. 8 is a plan view showing the structure of one subpixel region of the liquid crystal device according to the second embodiment. FIG. 8 corresponds to FIG. 2 showing the first embodiment.

In the liquid crystal device according to the second embodiment shown in FIG. 8, the strip electrodes 209c are arranged to form a meandering shape such that open ends B are alternately formed at first and second ends of the strip electrodes 209c. With this structure, a display operation with a high brightness, such as that shown in FIG. 5B, can be performed at least in the open end portions. Since the open ends B are alternately arranged in the second embodiment, the bright portion shown in FIG. 5B appears on both the left- and right-hand sides of the subpixel region. As a result, the brightness of the entire subpixel region can be equalized. The direction in which the strip electrodes 209c according to the second embodiment extend is parallel to the scanning lines 3a, as in the modification described above. When the X-axis direction is the horizontal direction, the rubbing direction is set to be within a range of about ±3° to ±15°.

### Electronic Apparatus

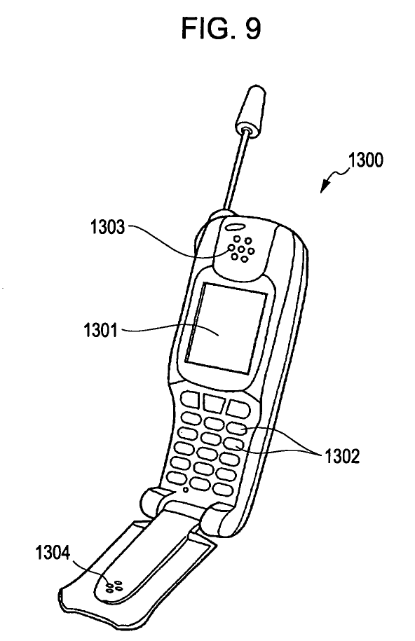

FIG. 9 is a perspective view of a cellular phone serving as an exemplary electronic apparatus having the liquid crystal device according to the embodiments of the invention as a display section. A cellular phone 1300 includes the liquid crystal device according to the embodiments of the invention as a small-sized display section 1301. The cellular phone 1300 further includes a plurality of operation buttons 1302, an earpiece 1303, and a mouthpiece 1304.

The liquid crystal device according to the embodiments of the invention can be used, not only as the display section of the cellular phone, but also as image display sections of other electronic apparatuses, such as digital books, personal computers, digital still cameras, liquid crystal televisions, view-finder-type or monitor-direct-view-type video recorders, car navigation systems, pagers, digital diaries, calculators, word-processors, workstations, videophones, point-of-sale (POS) terminals, and apparatuses equipped with a touch panel. In any of these electronic apparatuses, the liquid crystal device can perform a display operation with a high brightness.

While the invention has been described with reference to exemplary embodiments with reference to the accompanying drawings, it is to be understood that the invention is not limited to the disclosed embodiments. That is, various configurations and combinations of the components in the above-described embodiments are examples only, and various modifications may be made in accordance with design factors or the like, without departing from the spirit of the invention. For example, an open end of each pixel electrode is provided on one side or two sides of each subpixel region in the first and second embodiments and the modification. Alternatively, for example, the backbone portion 9a may be provided at the center of the strip electrodes 9c, thereby providing open ends on both the left- and right-hand sides of each subpixel region. In addition, the invention is applicable to a transflective liquid crystal device by including a reflective film or the like in part of the common electrode 19.

The entire disclosure of Japanese Patent Application No. 2006-157010, filed Jun. 6, 2006 is expressly incorporated by reference herein.

What is claimed is:

1. A liquid crystal device comprising:
a first substrate and a second substrate facing each other with a liquid crystal layer held therebetween;
first electrodes and second electrodes provided on a surface of the first substrate, the surface facing toward the liquid crystal layer;
data lines and scanning lines provided on the surface of the first substrate, the surface facing toward the liquid crystal layer, the data lines and the scanning lines intersecting one another; and
switching elements connected to the corresponding data lines and the corresponding scanning lines,
wherein the alignment of liquid crystal molecules of the liquid crystal layer is controlled by an electric field induced between the first and second electrodes,
wherein the first electrodes are arranged in corresponding pixel regions enclosed by the data lines and the scanning lines,
wherein each of the second electrodes has a plurality of branch electrodes extending in a direction intersecting a corresponding one of the data lines and a connecting portion electrically connecting the branch electrodes with one another such that at least one of first and second ends of the adjacent branch electrodes is open, and
wherein the second electrodes are arranged such that each of the second electrodes partially overlaps a corresponding one of the first electrodes in a corresponding one of the pixel regions when viewed in plan.

2. The liquid crystal device according to claim 1, wherein the connecting portion is provided to connect to the first ends of the branch electrodes, and the second ends of the branch electrodes are open.

3. The liquid crystal device according to claim 1, wherein the connecting portion is provided such that the first and second ends of the adjacent branch electrodes are alternately open.

4. The liquid crystal device according to claim 1, wherein, when viewed in plan, a positional displacement between one of the first and second ends of each of the branch electrodes of each second electrode, the one end being open facing toward a corresponding one of the data lines, and one end of a corresponding one of the first electrodes adjacent to the corresponding one of the data lines is set to be less than or equal to 5 μm.

5. The liquid crystal device according to claim 1, wherein an initial alignment direction of the liquid crystal molecules coincides with a direction of an electric field induced between the data lines and the first electrodes, and the initial alignment direction of the liquid crystal molecules intersects the direction in which the branch electrodes extend.

6. A liquid crystal device comprising:
a first substrate and a second substrate facing each other with a liquid crystal layer held therebetween;
first electrodes and second electrodes provided on a surface of the first substrate, the surface facing toward the liquid crystal layer;
data lines and scanning lines provided on the surface of the first substrate, the surface facing toward the liquid crystal layer, the data lines and the scanning lines intersecting one another; and
switching elements connected to the corresponding data lines and the corresponding scanning lines,
wherein the alignment of liquid crystal molecules of the liquid crystal layer is controlled by an electric field induced between the first and second electrodes,
wherein the first electrodes are arranged in corresponding pixel regions enclosed by the data lines and the scanning lines,
wherein the second electrodes are arranged such that at least part of each of the second electrodes overlaps a corresponding one of the first electrodes in a corresponding one of the pixel regions when viewed in plan, and
wherein each of the second electrodes has a plurality of branch electrodes formed by a plurality of slits crossing over at least one outer peripheral side of the second electrode adjacent to a corresponding one of the data lines and extending in a direction intersecting the corresponding one of the data lines, and at least one of two ends of each of the slits is open toward the outside of the second electrode.

7. An electronic apparatus comprising a liquid crystal device according to claim 1.
